(19) United States
(12) Patent Application Publication
(10) Pub. No.: US 2011/0119268 A1
(43) Pub. Date: May 19, 2011

(54) METHOD AND SYSTEM FOR SEGMENTING QUERY URLS

(76) Inventors: Shyam Sundar Rajaram, Mountain View, CA (US); George Forman, Port Orchard, WA (US); Evan R. Kirshenbaum, Mountain View, CA (US)

(21) Appl. No.: 12/618,170

(22) Filed: Nov. 13, 2009

(51) Int. Cl. G06F 17/30

(52) U.S. Cl. 707/737; 707/E17.112; 707/E17.119

(57) ABSTRACT

A computer implemented method of grouping query URLs is provided. The method includes obtaining a plurality of query URLs generated at a plurality of Websites. The method also includes analyzing the query URLs to identify similarities between the URLs. The method also includes grouping the query URLs into cases based, at least in part, on the similarities, wherein each case comprises a plurality of instances, and each instance comprises a plurality of data field values corresponding to data fields with a same data field name.

### BACKGROUND

Marketing on the World Wide Web (the Web) is a significant business. Users often purchase products through a company's Website. Further, advertising revenue can be generated in the form of payments to the host or owner of a Website when users click on advertisements that appear on the Website. The online activity of millions of Website users generates an enormous database of potentially useful information regarding the desires of customers and trends in Internet usage. Understanding the desires and trends of online users may allow a business to better position itself within the online marketplace.

However, processing such a large pool of data to extract the useful information presents many challenges. For example, the different online entities that generate electronic documents may use different techniques or codes to represent similar information. Techniques for identifying the significance of certain information may not be readily available.

### BRIEF DESCRIPTION OF THE DRAWINGS

Certain exemplary embodiments are described in the following detailed description and in reference to the drawings, in which:

FIG. 1 is a block diagram of a system that may be used to generate cases for use in developing a classifier, in accordance with exemplary embodiments of the present invention;

FIG. 2 is a process flow diagram of a method for generating cases from raw electronic data, in accordance with exemplary embodiments of the present invention;

FIG. 3 is a graphical representation of an exemplary case, in accordance with exemplary embodiments of the present invention;

FIG. 4 is a process flow diagram of a method for generating cases based on similarities among the data field names, in accordance with exemplary embodiments of the present invention;

FIG. 5 is a process flow diagram of a method for generating cases based on statistical features of the data field values, in accordance with exemplary embodiments of the present invention;

FIG. 6 is a process flow diagram of a method for generating cases based on an edit distance, in accordance with exemplary embodiments of the present invention;

FIG. 7 is a process flow diagram of a method for adding a newly acquired query URL to an existing case, in accordance with exemplary embodiments of the present invention; and

FIG. 8 is a block diagram showing a tangible, machine-readable medium that stores code configured to generate a classifier, in accordance with an exemplary embodiment of the present invention.

### DETAILED DESCRIPTION OF SPECIFIC EMBODIMENTS

Exemplary embodiments of the present invention provide techniques for segmenting query URLs into groupings that may be used to obtain training data for generating a classification schema. As used herein, the term “exemplary” merely denotes an example that may be useful for clarification of the present invention. The examples are not intended to limit the scope, as other techniques may be used while remaining within the scope of the present claims.

In exemplary embodiments of the present invention, a collection of raw electronic data comprising data fields is obtained for a plurality of online entities and users. Selected portions of the raw data may be presented by a training system to a trainer that labels the data fields according to whether the data field contains data of the target class. The input from the trainer may be used by the training system to develop a classifier. When a sufficient amount of the raw data has been labeled by the trainer as belonging to the target class, the training system may automatically apply the classifier to the remaining data to identify additional data belonging to the target class within the remaining data.

In some exemplary embodiments of the present invention, the raw data will include query URLs representing Web searches performed by a plurality of Internet browsers at a plurality of Websites, and the target class may include data fields that contain user entered search terms. Developing a classifier for automatically identifying the search terms in the query URL may enable data mining techniques that can provide substantial information regarding the desires of online consumers. Exemplary techniques for generating a classifier are discussed further in the commonly assigned and co-pending U.S. patent application Ser. No. ______, filed on ______, 2009, entitled “Method and System for Developing a Classification Tool,” by Evan R. Kirshenbaum, et al., and the commonly assigned and co-pending U.S. patent application Ser. No. ______, filed on ______, 2009, entitled “Method and System for Developing a Classification Tool,” by Evan R. Kirshenbaum, et al., both of which are hereby incorporated by reference as though fully set forth in its entirety herein. Exemplary data mining techniques are discussed further in the commonly assigned and co-pending U.S. patent application Ser. No. ______, filed on ______, 2009, entitled “Method and System for Processing Web Activity Data,” by George Forman, et al., which is hereby incorporated by reference as though fully set forth in its entirety herein.

The raw data may be divided into groupings, referred to herein as “cases,” that share some common characteristic, for example, a common data structure or a common source. The classifier may present an entire case of data to the trainer for evaluation rather than just one example of the data field or one query URL. Thus, different examples of the same data field may be evaluated by the trainer in the context of an entire case, which may enable the trainer to more readily identify patterns that reveal the usage of the data field and lead to a more accurate labeling of the data field. Furthermore, several data fields may be labeled simultaneously, rather than one at a time. Faster and more accurate techniques for labeling the data field may reduce the amount of time and labor used to develop the classification schema and increase the accuracy of the classification schema.

Accordingly, exemplary embodiments of the present invention provide techniques for segmenting query URLs into cases. The term “case” is used to refer to a collection of data components such as query URLs whose data fields co-occur in a way that enables the data components to be grouped together and processed as a group, for example, by the training system. In one exemplary embodiment, a sorted list of data field names is generated from each of the URLs. The list may be used to generate cases by aggregating other URLs with similar data field names. In another exemplary embodiment, URLs with similar data fields are identified, and various statistical features of the data field values may be generated via a statistical analysis of the data field values. A nearest-neighbor technique may be used to group similar query URLs into cases. In another exemplary embodiment, an edit distance is computed to compare pairs of query URLs. The edit distance may be used to group similar query URLs into cases. In yet another exemplary embodiment of the present invention, the generated cases are analyzed to determine descriptions of the cases, which may take the form of rules or patterns and which may be added to an index. The index may be used to add newly acquired query URLs to an existing case.

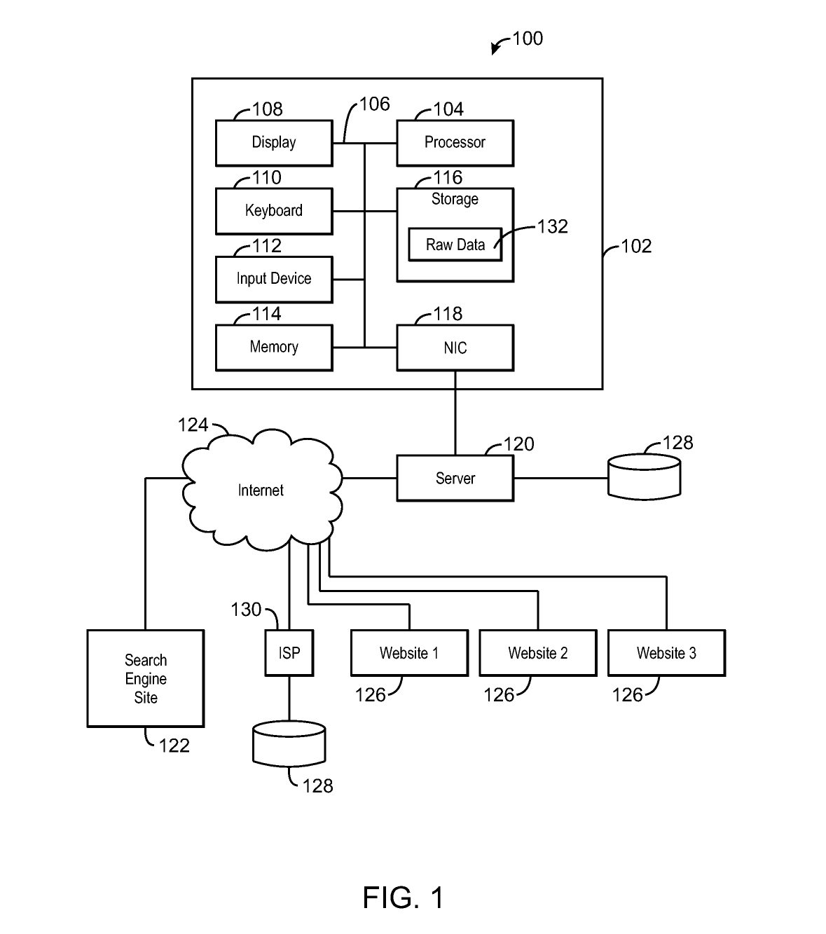

FIG. 1 is a block diagram of a system that may be used to generate cases for use in developing a classifier, in accordance with exemplary embodiments of the present invention. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are only one example of functional blocks and devices that may be implemented in an exemplary embodiment of the present invention. Those of ordinary skill in the art would readily be able to define specific functional blocks based on design considerations for a particular electronic device.

As illustrated in FIG. 1, the system 100 may include a computing device 102, which will generally include a processor 104 connected through a bus 106 to a display 108, a keyboard 110, and one or more input devices 112, such as a mouse, touch screen, or keyboard. In exemplary embodiments, the device 102 is a general-purpose computing device, for example, a desktop computer, laptop computer, business server, and the like. The device 102 can also have one or more types of tangible, machine-readable media, such as a memory 114 that may be used during the execution of various operating programs, including operating programs used in exemplary embodiments of the present invention. The memory 114 may include read-only memory (ROM), random access memory (RAM), and the like. The device 102 can also include other tangible, machine-readable storage media, such as a storage system 116 for the long-term storage of operating programs and data, including the operating programs and data used in exemplary embodiments of the present invention.

In exemplary embodiments, the device 102 includes a network interface controller (NIC) 118, for connecting the device 102 to a server 120. The computing device 102 may be communicatively coupled to the server 120 through a local area network (LAN), a wide-area network (WAN), or another network configuration. The server 120 may have a machine-readable media, such as storage array, for storing enterprise data, buffering communications, and storing operating programs of the server 120. Through the server 120, the computing device 102 can access a search engine site 122 connected to the Internet 124. In exemplary embodiments of the present invention, the search engine 122 includes generic search engines, such as GOOGLE™, YAHOO®, BING™, and the like. The computing device 102 can also access Websites 126 through the Internet 124. The Websites 126 can have single Web pages, or can have multiple subpages. Although the Websites 126 are actually virtual constructs that are hosted by Web servers, they are described herein as individual (physical) entities, as multiple Websites 126 may be hosted by a single Web server and each Website 126 may collect or provide information about particular user IDs. Further, each Website 126 will generally have a separate identification, such as a uniform resource locator (URL), and will function as an individual entity.

The Websites 126 can also provide search functions, for example, searching subpages to locate products or publications provided by the Website 126. For example, the Websites 126 may include sites such as EBAY®, AMAZON.COM®, WIKIPEDIA™, CRAIGSLIST™, CNN.COM™, and the like. Further, the search engine site 106 and one or more of the Websites 126 may be configured to monitor the online activity of a visitor to the Website 126, for example, regarding searches performed by the visitor.

The computing device 102 and server 120 may also be able to access a database 128, which may be connected to the server 120 through the local network or to an Internet service provider (ISP) 130 on the Internet 124, for example. The database 128 may be used to store a collection of raw electronic data to be processed in accordance with exemplary embodiments of the present inventions. As used herein, a “database” is an integrated collection of logically related data that consolidates information previously stored in separate locations into a common pool of records that provide data for an application.

The computing device 102 may also include a collection of raw electronic data 132 which may be processed to generate cases. In some exemplary embodiments, the raw electronic data 132 includes Web activity data for a plurality of Internet browsers visiting a plurality of Websites. For example, the raw electronic data 132 may include records of the Web pages clicked on by individual browsers, the HTML content of Web pages, the results of Web searches that have been performed at various Websites, and the like. The raw electronic data 132 may also include URL data, for example, a collection of query URLs that represent searches performed by a Web browser. The raw electronic data may be provided to the computing device 102 via a storage medium, for example, the database 128, a portable storage medium such as a compact disk (CD), and the like.

The computing device 102 may be used to generate cases from the raw electronic data 132, as discussed herein. The cases may be stored, for example, to the storage system 116 or to the database 128. The resulting case data may be used in a variety of ways. In one embodiment, the cases may be used to analyze relative amounts of Internet traffic, which may be grouped into cases that represent different geographies or user classes, for example. In another embodiment, the cases may be used to provide input to a collaborative filtering algorithm.

In some exemplary embodiments, the computing device 102 will also include a training system configured to generate a classifier using the generated cases. In other exemplary embodiments, the cases will be stored for use by a training system included on a separate computing device. The training system may present cases to a trainer that provides training information to the training system in the form of labels that are applied to each of the data fields in the presented case. For example, the training system may display the case on the display 108 and the trainer may provide training data via the input device 112 by selecting one or more data fields of the case as belonging to the target class. The training data may be used to develop a classifier, which may be used to automatically identify target classes in unlabeled cases and other electronic data, such as newly acquired query URLs. It will be appreciated that the above system description represents only a few of the possible arrangements of a system for developing a cases in accordance with embodiments of the present invention. Additionally, the present invention is not limited to a particular use of the generated cases. Furthermore, for purposes of clarity, the exemplary embodiments of the present invention described in further detail herein may refer to generating cases from raw data that includes query URLs that have been generated by a plurality of browsers at a plurality of Websites.

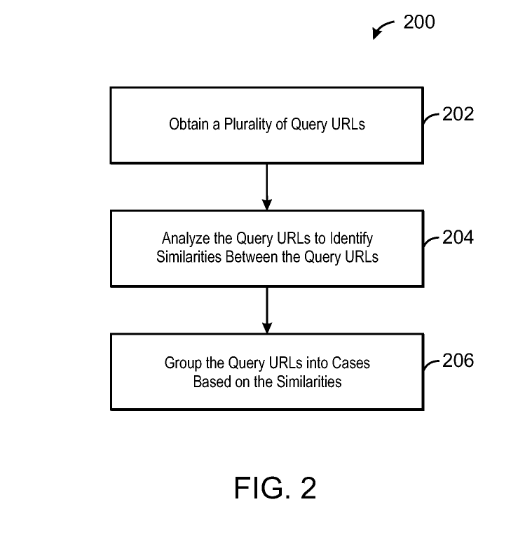

FIG. 2 is a process flow diagram of a method for generating cases from raw electronic data, in accordance with exemplary embodiments of the present invention. The method is generally referred to by the reference number 200 and begins at block 202, wherein a plurality of query URLs may be obtained. The raw electronic data may include any suitable electronic data, as described above in relation to FIG. 1.

In exemplary embodiments of the present invention, the raw electronic data 132 includes a collection of query URLs obtained by directly monitoring Web activity generated at a plurality of Websites by plurality of users. For example, with reference to FIG. 1, the server 120 may monitor the online activity of several client computing devices 102. In other exemplary embodiments, the URL data is obtained from a third party, such as one or more Websites 126, an ISP 130, internet monitoring service, search engine site 106, and the like. Furthermore, in some embodiments the URL data may be obtained from the website logs of multiple organizations' Websites. In some embodiments, URL data may be obtained by gathering click-stream logs from multiple users via monitoring software installed on their client computers (either in the OS or in the browser or separate opt-in service). In some embodiments, URL data may be obtained by collecting the click-stream logs observed by one or more ISPs or Internet backbone providers that monitor Web traffic from many users to many Websites.

A query URL will generally be of the form:

http://www.website.com/a/b/c?k1=v1&k2=v21+v22&k3=v3.

In this query URL, the hostname is generally the portion of the URL that precedes the first single forward slash, in this case “http://www.website.com”, the path is everything from the first single forward slash (when one exists) that precedes the question mark, in this case “/a/b/c”, and the query portion of the query URL is everything that follows the question mark. As used herein, the term “Website name” is used to refer to any combination of components from the hostname and components from the path. Furthermore, the query portion of the query URL may include one or more data fields, which may be separated by ampersands. Each data field may include a data field name, e.g., “k1,” and a data field value, e.g., “v1.” In the example query URL provided above, the query URL includes three data fields, namely “k1,” which has the value “v1,” “k2,” which has the value “v21+v22,” and “k3,” which has the value “v3.”

It will be appreciated that the naming convention used herein is hypothetical and that any suitable character string may be used to represent the various data field names and values used in an actual query URL. The naming convention used in the query URL may be an ad hoc convention designated for a single Web form or Website. Therefore, a common naming convention used across the multiple Websites may not be available. For example, a hypothetical query field named “q” may refer to different types of data. In one query URL, “q” may refer to data field that holds a search term entered by a user. However, in another query URL, “q” may refer to something different, for example a data field that holds a desired quantity of a product. Moreover, a tool for translating among the various naming conventions may not be available. Accordingly, exemplary embodiments of the present invention analyze some aspect of the query URL to identify query URLs whose query fields are similar enough to be grouped into cases, as described in reference to block 204.

At block 204, the data fields of the query URLs may be processed to automatically identify similarities among the query URLs. As used herein, the term “automatically” is used to denote an automated process performed by a machine, for example, the computing device 102. It will be appreciated that various processing steps may be performed automatically even if not specifically referred to herein as such.

In some exemplary embodiments of the present invention, the query URLs are analyzed to identify similarities among the Web page addresses of the query URLs. For example, query URLs may be identified that have a common Website name, for example, a common hostname or path. Furthermore, a set of normalization rules may be applied to the query URLs to eliminate small differences, thus enabling more query URLs to be grouped into a single case. One exemplary normalization rule may include setting each letter of a query URL to lowercase. Another exemplary normalization rule may include eliminating a port designation from the query URL's Web page address. For example, a hypothetical query URL may include a hostname with a port address, for example, “http://www.foo.com:8000.” In this case, the query URL may be converted to “http://www.foo.com.” Another exemplary normalization rule may include eliminating or modifying a component or portion of a component from a hostname, for example, a component that is determined to refer to a particular Website server. In this case, hostnames such as “www1.google.com,” and “www2.google.com” may be converted to “www.google.com” or more simply “google.com.” In another exemplary embodiment, a normalization rule includes eliminating a leading component from a group of hostnames that have similar search forms but different host prefixes. For example, some Websites such as Craigslist use multiple hosts with location-based variants, such as “Seattle.craigslist.org,” or “Houston.craigslist.org.” In this case, the normalization rule would result in converting both hostnames into a single simplified version of the hostname, for example, “craigslist.org.”

Another normalization rule may include removing all hostname components prior to one component prior to a top-level domain (TLD), where a TLD is a suffix of the list of components that is considered to represent hierarchy within the DNS namespace management above the level of an individually-allocated domain. As an example, “.com” and “.edu” may be considered to be TLDs. Country-specific domains, such as “.uk” and “.mx” may also be considered to be TLDs, but in some embodiments, sub-domains of such domains, such as “.co.uk” and “.gob.mx” may be considered TLDs. TLDs may have any number of components, so, for example, “.pvt.k12.ny.us” may be considered to be a TLD used for registering private elementary schools in the state of New York. In such an embodiment, “www.shopping.hp.com” might be normalized to “hp.com”, and “news.google.co.uk” might be normalized to “google.co.uk”. In some embodiments, normalization may involve removal of TLDs, resulting in “mail.hp.com” and “mail.hp.co.uk” both normalizing to “mail.hp”.

By applying normalization rules such as those discussed above, query URLs with a similar hostname or path may be identified despite small differences such as different Website prefixes, different letter case, different port designations, and the like. In some embodiments, the normalization rules may be defined based on knowledge of the hostname conventions used by various commonly-visited Websites and stored in an index. Upon receiving a set of query URLs, each query URL may be automatically compared to the index to determine whether a particular normalization rule applies. The normalization rule may be automatically applied to convert the query URL according to the normalization rule.

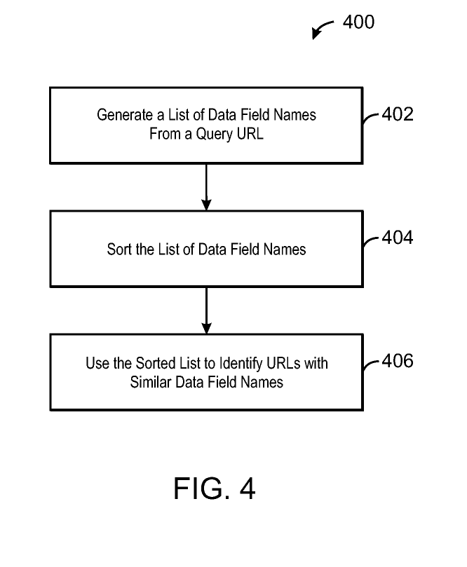

In some exemplary embodiments, the query URLs are analyzed to identify similarities in the query fields of the query URLs. Techniques for analyzing the query fields of the query URLs are discussed further in relation to FIGS. 4-6.

At block 206, the query URLs may be grouped together according to the identified similarities. In one exemplary embodiment, the query URLs that have a common hostname or common normalized hostname will be grouped together into cases. For example, query URLs with the normalized hostname “craigslist.org” may be grouped together into the same case. In another exemplary embodiment, the query URLs that have a common hostname and path or common normalized hostname and path will be grouped together into cases. For example, all query URLs with the normalized hostname and path “www.foo.com/here” may be grouped together into one case, while query URLs with the normalized hostname and path “www.foo.com/there” may be grouped together into a different case. Furthermore, query URLs with the same hostname and path may be further divided into several cases based on the identified similarities in the query fields of those URLs.

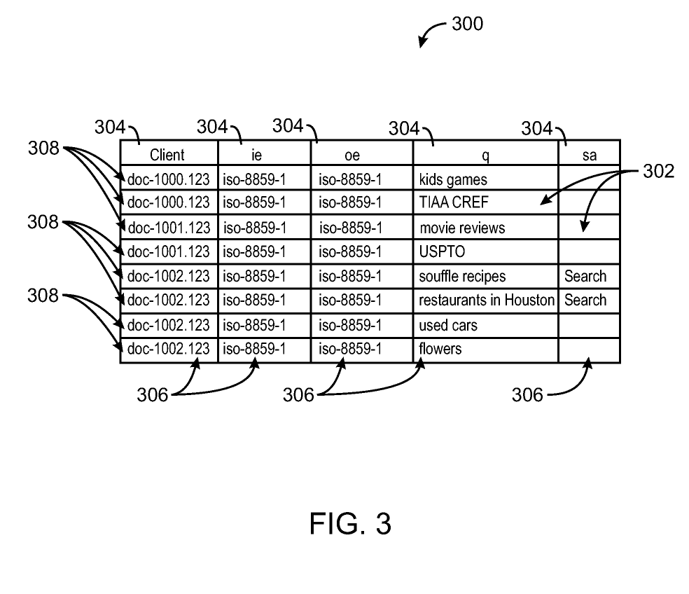

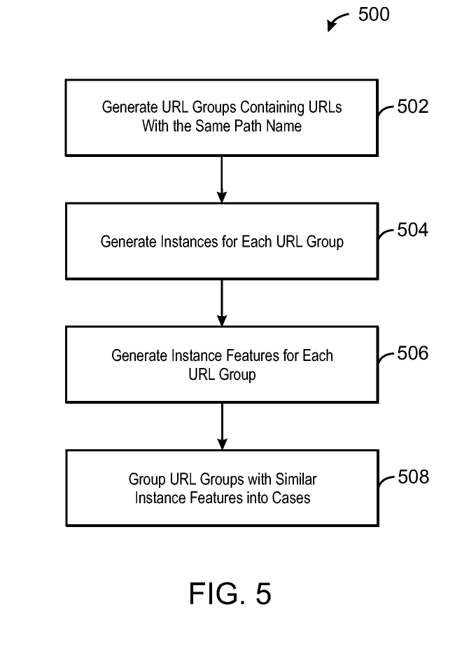

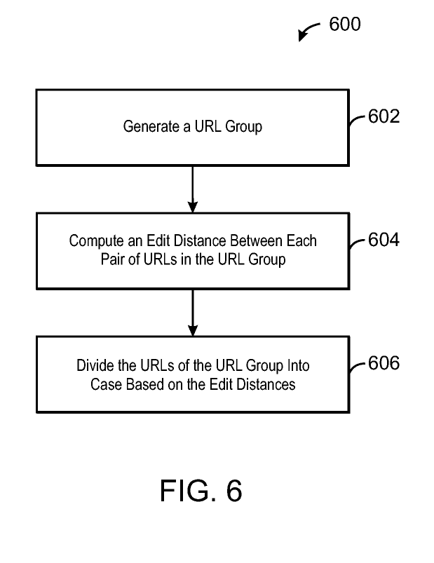

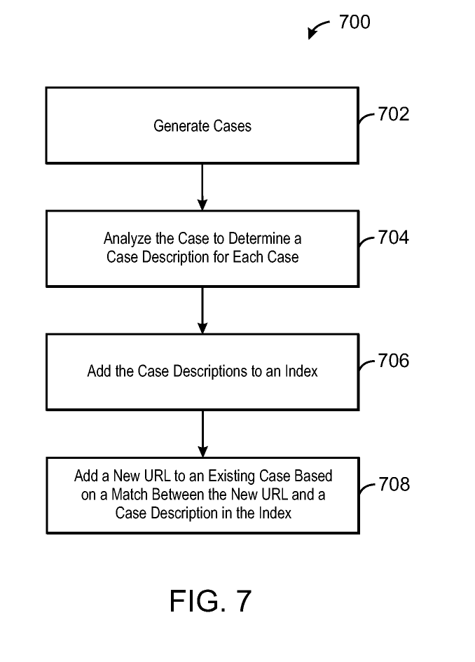

Exemplary embodiments of the present invention provide techniques for grouping query URLs into cases based on identifying similarities among the data fields of the query URLs and the query URLs as a whole, including the data fields and the Web page address of the query URLs. An exemplary case generated in accordance with the techniques disclosed herein is described in relation to FIG. 3. Techniques for using a sorted list of data field names to generate cases are discussed in relation to FIG. 4. Techniques for using statistical features of the data field values to generate cases are discussed in relation to FIG. 5. Techniques for using an edit distance between query URLs are discussed in relation to FIG. 6. Furthermore, techniques for adding newly acquired query URLs to an existing case are discussed in relation to FIG. 7.

FIG. 3 is a graphical representation of an exemplary case, in accordance with exemplary embodiments of the present invention. As shown in FIG. 3, the case 300 may be represented as a matrix of data field values 302. Each of the data field values 302 may be associated with a corresponding data field name 304. Furthermore, the case 300 may include instances 306 and examples 308. The instances 306 may be represented as individual columns that include data field values 302 with the same data field name 304. Each example 308 may be represented as an individual row that includes the data field values 302 from a single query URL. It will be appreciated that the exemplary case depicted in FIG. 3 is one hypothetical case that may be generated, depending on the query URL data obtained. For example, other hypothetical cases may include thousands of instances and tens of millions of examples.

FIG. 4 is a process flow diagram of a method for generating cases based on similarities among the data field names, in accordance with exemplary embodiments of the present invention. The method is generally referred to by the reference number 400 and begins at block 402, wherein a list of data field names may be generated for each of the query URLs. The data field names may be obtained from the query URLs via textual parsing of the query field.

At block 404, each list of data field names may be sorted, for example, arranged in alphabetical order. Further, the data fields of each data field list may also be normalized, for example, set all to lowercase and the like. Additionally, each data field list and/or the data fields of each data field list may also be converted to a hash value. In some exemplary embodiments, each data field list will also include the normalized hostname of the query URL corresponding to the data field list. The data field lists or hashes thereof, along with information sufficient to identify the associated URLs, may be stored in a storage array for further processing, wherein each element of the array includes a representation of one data field list from a single query URL. In some exemplary embodiments, the storage array is implemented as a file or collection of files, with each element of the array represented as a line. In other exemplary embodiments, the storage array is implemented by means of a database table or tables.

At block 406, the storage array is sorted such that elements that contain identical data field lists are contiguous in the resulting sorted array. The sorted array is processed to identify URLs in consecutive elements that have identical data field lists and consider those URLs to constitute a case.

In an alternative embodiment, at block 404, an associative array, which may be implemented by means of a database or an in-memory data structure such as a hash table, is used to associate data field lists (or some key, such as a hash computed on a data field list) with sets of URLs associated with the data field lists. At block 406, the sets of URLs associated with distinct data field lists may be used to define cases. In some embodiments, a MapReduce framework may be used. In such an embodiment, during the Map phase URLs may be associated with data field lists. During the Reduce phase all URLs associated with a given data field list may be collecting together and grouped into a case.

In exemplary embodiments, the match among data field lists is not exact. Rather, the data field lists that have an allowable level of variation may be considered to match. For example, a matching data field list may be defined as a data field list that varies from the key in one of the data field names. In some embodiments, other notions of similarity, for example those described in relation to edit distances with respect to FIG. 6, may be used. In an exemplary embodiment involving sorted arrays, the storage array is sorted at block 404 in such a way that not only do elements with identical data field lists sort to form a contiguous region, but elements whose data fields are considered to be similar, using some similarity metric such as the number of data fields they have in common, tend to sort to be nearby one another. In such an embodiment, at block 406, when an identified case defined by a contiguous sequence of elements with identical data field lists is not at least of a specified size, it may be combined with one or more cases defined by nearby elements, optionally after testing to ensure that such nearby cases are in fact sufficiently similar. In another exemplary embodiment, once cases are identified, they are determined to be sufficiently large or not by comparing against a threshold. Insufficiently large cases are compared against other cases (or sufficiently large cases) using a technique such as one described with respect to FIG. 5 or FIG. 6. When an insufficiently large case is found to be sufficiently close to another case, the two cases are merged into one case. The process terminates when there are no remaining insufficiently large cases or no insufficiently large case is close enough to another case to warrant merging. In a further alternative embodiment, data field lists associated with sufficiently large cases are examined and hypothetical data field lists are constructed, as by leaving out one of the data fields. If an insufficiently large case has a data field list that matches a hypothetical data field list, the two cases are merged.

FIG. 5 is a process flow diagram of a method for generating cases based on statistical features of the data field values, in accordance with exemplary embodiments of the present invention. The method is generally referred to by the reference number 500 and begins at block 502, wherein URL groups may be generated. In some exemplary embodiments, each URL group will include query URLs that have the same hostname and path. In other embodiments, each URL group may include query URLs with the same hostname. Furthermore, in both cases, the path or hostname may be normalized, as discussed above in relation to FIG. 2.

At block 504, instances may be generated for each query URL group. As used herein, the term “instance” refers to a collection of data field values that originate from data fields having the same data field name and occurring within the same group. Each data field name included in the URL group may correspond with a different instance. Each of the data field values associated with a particular data field name may be assigned to the corresponding instance. Furthermore, each instance may include an instance value for each of the query URLs in the URL group. If a particular query URL of the URL group does not include a data field corresponding with a particular instance, the instance value added to the instance for that query URL may be null, the empty string, or zero.

At block 506, instance features may be generated for each URL group. As used herein, an instance feature is a statistical characteristic relating to some aspect of the data field values included in the instance, for example, the number of letter characters in the instance, the percentage of letter characters relative to numerical characters in the instance, and the like. One example of an instance feature may include the percentage of query URLs that are unique, for example, the combination of data values for the query URL are not repeated within the URL group. Another example of an instance feature may include the percentage of data field values that are unique for a particular instance, for example, occurring only once within the instance. Another example of an instance feature may include the percentage of data field values that are missing or empty for a particular instance.

Further examples of instance features may include, but are not limited to the minimum, maximum, median, mean, and standard deviation of individual string features over the data field values within an instance. The individual string features may include values such as the string length, the number of letters in the string, the number of words in the string, the number of whitespace characters in the string, and whether the string is all whitespace. Additional string features may include the number of characters in the string that are capitalized, the number of lowercase characters in the string, the number of numerical values in the string, and the average word length of the string. Further string features may include the number of control characters in the string, the number of hexadecimal digits or non-hexadecimal letters in the string, the number of non-ASCII characters in the string, the number of individual punctuation characters (“@”, “.”, “$”, “_”, etc.) in the string, and the like. In some embodiments, instance features may further relate to metadata associated with the corresponding fields rather than the instance values. For example, instance features may be based on a tag, keyword, or name of the field, alone or in the context of similar metadata for other instances in the case. In various embodiments, one or more instance features such as those discussed above may be generated for each instance and added to a feature vector. In this way, each URL group may be represented as a bag of feature vectors.

At block 508, the URL groups may be grouped into cases based on similarities among the instance features of each URL group. In some exemplary embodiments, the URL groups will be grouped into cases using a nearest neighbor algorithm applied to the feature vectors, for example, a locality-sensitive hashing algorithm, and the like.

FIG. 6 is a process flow diagram of a method for generating cases based on an edit distance, in accordance with exemplary embodiments of the present invention. The method is generally referred to by the reference number 600 and begins at block 602, wherein URL groups may be generated. The URL groups represent groups of query URLs that have a likelihood of belonging in the same case. In some exemplary embodiments, each URL group will include query URLs that have the same hostname and path. In other embodiments, each URL group may include query URLs with the same hostname. Furthermore, the path or hostname may be normalized, as discussed above in relation to FIG. 2. In some embodiments, all of the query URLs may be processed as a single URL group, and block 602 may be skipped. Each URL group may be further divided into cases based on the edit distances computed at block 604.

At block 604, for each query URL group, an edit distance may be computed between each pair of query URLs in the URL group. As used herein, the term “edit distance” refers to a value computed for a pair of query URLs by identifying edit operations sufficient to transform one of the query URLs into the other query URL. Exemplary edit operations will include an insertion, deletion, or substitution of a single element within the query URL, wherein each element may be a character, a string of characters, a data field, a path element, and the like. Each edit operation may be associated with a cost that may be added to the edit distance if the particular edit operation is identified for the URL pair. A set of edit rules may be provided to determine the cost associated with each edit operation. The costs specified for each edit operation may reflect the likelihood that the difference associated with the edit operation may be identified within query URLs that belong in different cases. High costs may be assigned to edit operations that suggest a high likelihood that the query URLs belong in different cases. Low costs may be assigned to edit operations that do not suggest a high likelihood that the query URLs belong in different cases.

In an exemplary embodiment, an edit operation will include adding elements to the hostname or replacing one element for another. In this case, the cost associated with adding or replacing an element at the left-hand side of the hostname may be lower than the cost associated with adding an element to the middle or right-hand side of the hostname. The difference in costs may reflect the fact that Websites often use different hostname prefixes to provide multiple hosts or multiple Web servers that have similar search forms. In some embodiments, the replacement of one TLD by another, for example converting “hp.com” to “hp.co.uk”, relatively inexpensive operation, reflecting the fact that some companies have presences in multiple countries, while the replacement of the component to the left of the TLD, for example converting “hp.com” to “ibm.com”, may be a relatively expensive operation, reflecting the fact that different sub-domains of a TLD tend to be owned by different entities. In other embodiments, the cost of replacement of a component to the left of the TLD may take into account the similarity of the strings, reflecting the fact that “hpshopping.com” and “hp.com” are more likely to be owned by a single entity than “hp.com” and “ibm.com”.

Furthermore, the cost of the edit operation may also take into account the type of elements added or replaced. For example, if the added element is the character string “www,” the cost may be low to reflect the fact that the prefix “www” is often considered optional. In another example, the cost of a replacement operation may be low if the replacement involves replacing one set of digits for another at the right-hand side of a hostname component. The low cost of this edit operation may reflect the fact that Websites often use different named servers, identified by number, for example “www-15” and “www-23”, to balance traffic.

In some exemplary embodiments, an edit operation will include adding or deleting data fields in the query field based on differences in the data field names. Each addition and deletion of a data field may count as one edit operation so that a replacement of one data field for another data field with a different name may count as two edit operations. The cost of field additions and deletions may increase non-linearly with the number of edit operations performed or the percentage of edit operations performed compared to the number of data fields in the query field. This may reflect the fact that Web forms generally have the same set of cases with one or two fields possibly being different. In this case, replacing two data fields in a query URL that only has two data fields may generate a higher score than adding two data fields to a query field that already has eight data fields, for example.

In another exemplary embodiment, an edit operation will include changing a data field value. This may reflect the fact that one of the data fields may often be used to identify a distinct mode of the query. For example, a data field named “operation” may have a small number of values, including “lookup” and “purchase”. The value of that data field may determine the other data fields included in the query field and how the other data fields are used. Furthermore, in some exemplary embodiments, each data field value will be identified as belonging to a specific type, for example, telephone number, number, hex string, word, multiword phrase, and the like. In this case, an additional cost may be associated with an edit operation that changes a data field value from one type to another. In another exemplary embodiment, the cost of removing a data field may be zero or near zero. In another exemplary embodiment, the URLs may first have all their data values removed, i.e., the edit distance is based on the hostname, path and field names, but not based on the values in the fields.

At block 606, for each query URL group, the query URLs may be further divided into cases based on the edit distances. Dividing each URL group into one or more cases may be accomplished using any suitable clustering or aggregation algorithm. In some exemplary embodiments, a distance threshold will be specified, and query URL pairs with edit distances below the threshold will be included in the same case. In other exemplary embodiments, a plurality of query URLs will be included in the same case if overall distance between the two outlying query URLs is less than the distance threshold.

In some embodiments, at block 604, edit distances may be computed between fewer than all of the pairs of URLs in a URL group. In some such embodiments, edit distances may be computed between each URL and a randomly-drawn subset of URLs in the group. In other such embodiments, edit distances may be computed between a URL and randomly-drawn URLs only until a sufficiently small edit distance is discovered. In some embodiments, blocks 604 and 606 may be performed simultaneously, with edit distances computed both between URLs not in cases and randomly-drawn representatives of existing cases and between URLs not in cases and other randomly-drawn URLs not in cases. In such an embodiment, URLs may be added to cases or grouped together to form cases whenever a sufficiently-small edit distance is found. In some such embodiments, URLs in cases may also be checked against other URLs in cases and as a result of the computed edit distance, URLs may be moved from one case to another, and cases may be merged or split.

Newly acquired query URLs may also be added to existing cases, after the cases have been generated. In some embodiments, new URLs may be added by computing an edit distance between the new URL and one or more representative URLs from each of the existing cases. The new URL may be added to the case for which the lowest edit distance was computed, unless the smallest edit distance is larger than the distance threshold. Furthermore, new URLs may be added to existing cases based on the edit distance regardless of the technique used to generate the existing cases. Additional methods of adding newly acquired query URLs to existing cases are described in relation to FIG. 7.

FIG. 7 is a process flow diagram of a method for adding a newly acquired query URL to an existing case, in accordance with exemplary embodiments of the present invention. The method is generally referred to by the reference number 700 and begins at block 702, wherein cases may be generated, according to the exemplary embodiments described herein.

At block 704, the cases generated at block 702 may be analyzed to determine a case description for each case. Each case description may include one or more case characteristics which may relate to some aspect of the query URLs included in the described case. The case characteristics may be fixed characteristics or variable characteristics and may related to any portion of the query URL, including the hostname, path, query field, and the like. Each case characteristic acts as a rule for determining whether a newly acquired URL should be included in the case associated with the case characteristic. In some embodiments, a case characteristic may be associated with a likelihood that a matching URL belongs to a case and a case characteristic may be associated with more than one case with different probabilities. The case characteristics identified for each case may be combined to form the case description. In some embodiments, the case descriptions may be generated automatically via statistical analysis of the query URLs.

Fixed characteristics may be characteristics that are present in each query URL of the described case. Fixed characteristics enable a new query URL to be added to the described case based, in part, on whether the new query URL also includes the fixed characteristic. For example, if each query URL in a given case includes the string “foo.com,” then a fixed characteristic identifying the common hostname element, “foo.com,” may be added to the case description. In this example, a new query URL may be added to the case if it also includes the hostname element “foo.com.”

Variable characteristics are characteristics that vary among the query URLs of the described case. Variable characteristics enable a new query URL to be added to the described case regardless of the value of the URL element corresponding to the variable characteristic. For example, if the query URLs in a given case include the hostname prefix “www[-nn],” where “[-nn]” is a string of digits that varies among the URLs, then a variable characteristic identifying the variation may be added to the case description. In this example, the new URL may be added to the case if the new URL includes the hostname element “www” followed by a string of digits, regardless of the value of the digits. Another example of a variable characteristic may include a path of “/dept/[string]/query,” where “[string]” may be any string of characters. In some exemplary embodiments, one or more variable characteristic will be associated with a variation threshold that describes the allowable variation of the variable characteristic. The variation threshold enables a new query URL to be added to the described case if the value of the URL element corresponding to the variable characteristic falls within the variation threshold. For example, a variable characteristic may include a data field with a variable data field name, and the variation threshold may describe two or more data field names that are allowable for the data field. In another example, a variable characteristic may include a data field with a variable data field value, and the variation threshold may describe a range of numbers or string of characters that may be included in the data field value.

In some exemplary embodiments, the case characteristic will also include a negative characteristic, which describes an element that is not present in any of the query URLs of the described case. A negative characteristic may be used to prevent a new URL from being added to a case if the new URL includes the negative characteristic. For example, a negative characteristic may include a data field with a particular data field name. Thus, a new URL with the data field name identified by the negative characteristic may excluded from the case. In some exemplary embodiments, the cases form a hierarchy and a URL is added to a case if it matches the case characteristics of the case and does not also match the positive characteristics (or does match a negative characteristic) of a case dominated in the hierarchy by the case.

At block 706, the case descriptions generated at block 604 may be added to an index that enables the case descriptions to be searched. The index may be stored in a tangible machine-readable medium, for example, the storage system 116.

At block 708, a newly acquired query URL may be added to an existing case based on a match between the new URL and one of the case descriptions in the index. Upon acquiring the new query URL, the index may be searched to identify a matching case. The case may be considered a matching case if the query URL adheres to the case characteristics associated with that case. Upon identifying a matching case, the newly acquired case may be grouped with the matching case.

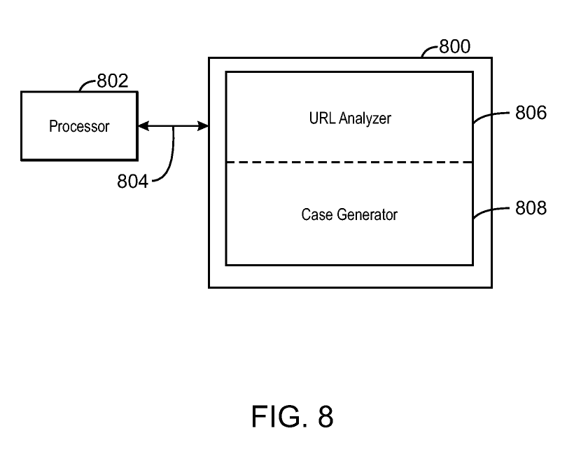

FIG. 8 is a block diagram showing a tangible, machine-readable medium that stores code configured to generate a classifier, in accordance with an exemplary embodiment of the present invention. The tangible, machine-readable medium is referred to by the reference number 800. The tangible, machine-readable medium 800 can comprise RAM, a hard disk drive, an array of hard disk drives, an optical drive, an array of optical drives, a non-volatile memory, a universal serial bus (USB) drive, a digital versatile disk (DVD), a compact disk (CD), and the like.

In some exemplary embodiments, the tangible, machine-readable medium 800 may store a collection of data comprising a query URLs generated by several browsers accessing Web forms from a plurality of Web sites. In one exemplary embodiment of the present invention, the tangible, machine-readable medium 800 will be accessed by a processor 802 over a communication path 804.

As shown in FIG. 8, the various exemplary components discussed herein can be stored on the tangible, machine-readable medium 800. For example, a first region 806 on the tangible, machine-readable medium 800 may store a URL analyzer configured to identify similarities among the URLs. A region 808 can include a case generator configured to group the query URLs into cases based on the similarities.

What is claimed is:

1. A computer implemented method of grouping query URLs, comprising:
obtaining a plurality of query URLs generated at a plurality of Websites;
analyzing the query URLs to identify similarities among the URLs; and
grouping the query URLs into cases based, at least in part, on the similarities, wherein each case comprises a plurality of instances, and each instance comprises a plurality of data field values corresponding to data fields with a same data field name.

2. The computer implemented method of claim 1, wherein analyzing the query URLs comprises generating an edit distance between a pair of the query URLs.

3. The computer implemented method of claim 2, wherein generating an edit distance comprises modifying the edit distance based, at least in part, on a cost associated with an edit operation.

4. The computer implemented method of claim 3, wherein the cost varies nonlinearly with a number of edit operations.

5. The computer implemented method of claim 1, wherein analyzing the query URLs comprises:
generating one or more URL groups, each URL group comprising query URLs that have a common Website name;
generating an instance for each URL group, the instance comprising one or more data field values within the URL group that are associated with a same data field name; and
generating an instance feature of the instance based, at least in part, on the data field values.

6. The computer implemented method of claim 5, wherein grouping the query URLs into cases comprises grouping two or more URL groups into a single case based, at least in part, on similarities among the instance features of the two or more URL groups.

7. The computer implemented method of claim 5, wherein grouping the query URLs into cases comprises grouping two or more URL groups into a single case using a nearest neighbor algorithm applied to the instance features of the two or more URL groups.

8. The computer implemented method of claim 1, wherein each query URL comprises a query field that includes one or more data field names, and analyzing the query URLs comprises:
generating a sorted list for each query URL, the sorted list comprising the data field names included in the query URL; and
comparing the sorted lists to identify matches among the query URLs.

9. The computer implemented method of claim 1, wherein analyzing the query URLs comprises generating a modified query URL based, at least in part, on a normalization rule.

10. The computer implemented method of claim 1, comprising analyzing the query URLs to identify case characteristics, and adding the case characteristics to a case description.

11. The computer implemented method of claim 1, comprising:
displaying the case; and
obtaining a label from a trainer, wherein the label identifies an instance of the case as belonging to a target class.

12. A computer system, comprising:
a processor that is configured to execute machine-readable instructions;
a memory device that is configured to store data comprising a plurality of query URLs generated at a plurality of Websites and instructions that are executable by the processor, the instructions comprising:
a URL analyzer configured to identify similarities among the URLs; and
a case generator configured to group the query URLs into cases based, at least in part, on the similarities, wherein each case comprises a plurality of instances, and each instance comprises a plurality of data field values corresponding to data fields with a same data field name.

13. The computer system of claim 12, comprising an index generator configured to generate a case description for each case, wherein a newly acquired query URL may be added to a case based, at least in part, on a degree of similarity between the newly acquired query URL and the case description associated with the case.

14. The computer system of claim 12, wherein:
each query URL comprises a query field that includes one or more data field names and one or more data field values;
the URL analyzer is configured to group data fields that have the same data field name into instances and generate one or more instance features based, at least in part, on the data field values in each instance; and
the case generator is configured to group the query URLs into cases, based, at least in part, on the instance features.

15. The computer system of claim 12, wherein the URL analyzer is configured to determine an edit distance between a pair of query URLs, and the case generator is configured to group the pair of query URLs into a case if the edit distance between the pair of query URLs is less than a specified threshold.

16. The computer system of claim 12, wherein each query URL comprises a data field that includes one or more data field names, and the URL analyzer is configured to generate a sorted list for each query URL comprising the data field names included in the query URL and compare the sorted lists to identify matches between the query URLs.

17. The computer system of claim 12, comprising a training system configured to display the case to a trainer and receive information about the case from the trainer, wherein the information may be used to generate a classifier.

18. A tangible, computer-readable medium, comprising code configured to direct a processor to:
obtain a plurality of query URLs generated at a plurality of Websites, each query URL comprising a query field that includes one or more data field names and one or more data field values;
identify similarities between the URLs; and
group the query URLs into cases based, at least in part, on the similarities.

19. The tangible, computer-readable medium of claim 18, comprising code configured to direct a processor to generate an edit distance between the query URLs and group the query URLs into cases if the edit distance between the query URLs is less than a specified threshold.

20. The tangible, computer-readable medium of claim 18, comprising code configured to direct a processor to group data fields that have the same data field name into instances, generate one or more instance features based, at least in part, on the data field values in each instance; and group the query URLs into cases based, at least in part, on the instance features
